(19) United States
(12) Patent Application Publication
(10) Pub. No.: US 2008/0297417 A1
(43) Pub. Date: Dec. 4, 2008

(54) LIGHT WEIGHT RUGGED MICROSTRIP ELEMENT ANTENNA INCORPORATING SKELETON DIELECTRIC SPACER

(75) Inventors: TIMOTHY B. AUSTIN, Stony Brook, NY (US); Mark W. Duron, East Patchogue, NY (US); Richard T. Knadle, Dix Hills, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Hotsville, NY (US)

(21) Appl. No.: 11/756,312

(22) Filed: May 31, 2007

(51) Int. Cl. H01Q 1/38; H01P 11/00

(52) U.S. Cl. 343/700 MS; 29/600

(57) ABSTRACT

Methods, systems, and apparatuses for manufacturing light weight microstrip element antennas incorporating a skeleton dielectric spacer instead of a regular solid body dielectric spacer is described. The microstrip element antenna comprises a radiator, a dielectric layer which is in the form of a skeleton rib-caged structure and a ground plane layer. Due to the skeleton rib-caged structure of the dielectric spacer, design flexibility in terms of a non-uniform variation of the effective dielectric constant across various dimensions of the dielectric layer is obtained. Additional advantages of such a dielectric spacer include a wider choice of materials from which the antenna can be made, overall light weight and low production time and machine cost due to lower cooling time of the dielectric. Further, an antenna with a skeleton dielectric spacer further has a better drying characteristics in an event of a water ingress during or post-production.

### BACKGROUND OF THE INVENTION

1. Field of the Invention

The invention relates to radio frequency identification (RFID) technology, and in particular, to a light weight low cost microstrip element antenna with a skeleton rib structured dielectric spacer.

2. Background Art

Radio frequency identification (RFID) tags are electronic devices that may be affixed to items whose presence is to be detected and/or monitored. RFID tags are read or interrogated by RFID readers on which one or more interrogator antennas reside. Such interrogator antennas on an RFID reader may include a microstrip element antenna, also known as a patch antenna, to transmit and receive information and energy to and from RFID tags. RFID tags themselves may include a microstrip element antenna, or similar antennas. Microstrip element antennas are mass produced multilayered devices including a radiator and a ground plane separated by a dielectric layer. Current microstrip element antennas have a solid body dielectric spacer sandwiched between the ground plane and the radiator. The presence of a solid dielectric spacer leads to an increase in the overall weight of the microstrip element antenna, restricts the designer to materials with appropriate dielectric properties and finally, increases the cost and time of production because solid body dielectric materials take longer to cool during the production process.

Further, in an event of a water or moisture ingress due to a varying humidity conditions during or post-production, solid body dielectric materials are more difficult to dry and take a longer time to dry.

Thus, what is needed are ways to design light weight, low-cost microstrip element antenna with adjustable dielectric properties having adjustable dielectric design features.

### BRIEF SUMMARY OF THE INVENTION

Methods, systems, and apparatuses for improved process for manufacture of a low cost laminated microstrip element antenna with adjustable dielectric properties are described herein.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary environment in which RFID readers, on which microstrip element antennas may reside, communicate with an exemplary population of RFID tags, on which microstrip element antennas may reside.

FIG. 2 illustrates a microstrip element antenna, according to an embodiment of the present invention.

FIG. 3 illustrates a cross-section of a dielectric spacer showing a skeleton rib structured geometry.

FIG. 4A illustrates studs attached to dielectric spacer in preparation for staking process.

FIG. 4B illustrates an exemplary assembly process for staking ground plane and radiator of a microstrip element antenna with the dielectric spacer sandwiched in between them.

FIG. 5 illustrates a flowchart showing a process for staking.

FIG. 6 shows an alternative design of a microstrip element antenna for further reduction in weight and tolerance to water and moisture ingress.

FIG. 7 shows an exemplary variation in dielectric constant of a microstrip element antenna with respect to its physical dimensions.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

Methods, systems, and apparatuses for RFID devices are described herein. In particular, methods, systems, and apparatuses for design and production of a light weight low cost antenna with a skeleton rib structured dielectric spacer layer sandwiched between a ground plane layer and a radiator layer are described.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System

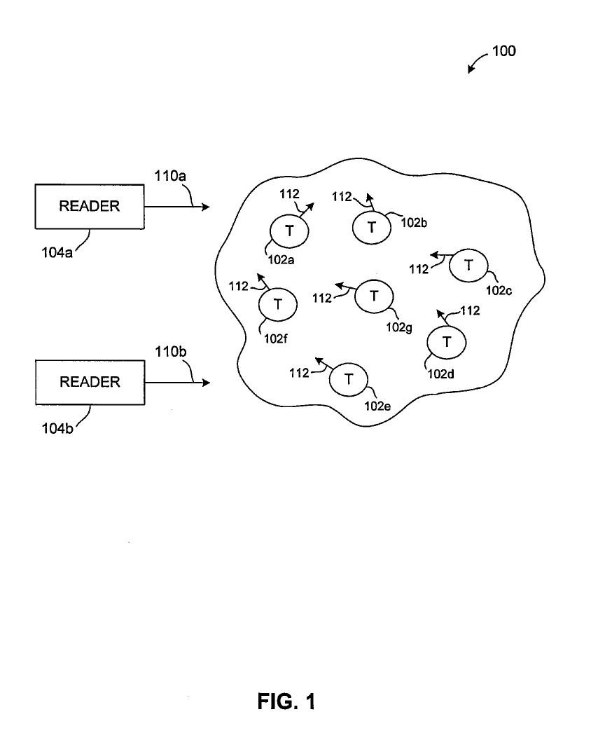

Before describing embodiments of the present invention in detail, it is helpful to describe an example RFID communications environment in which the invention may be implemented. FIG. 1 illustrates an environment 100 where RFID tag readers 104, on which microstrip element antennas may reside, communicate with an exemplary population 120 of RFID tags 102, on which microstrip element antennas may reside. As shown in FIG. 1, the population 120 of tags includes seven tags 102a-102g. A population 120 may include any number of tags 102. Each RFID tag reader 104 includes, amongst other elements, one or more microstrip element antenna. Depending on specific applications, each of tags 102a-102g may also include one or more microstrip element antenna.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This is facilitated by the presence of the microstrip element antenna array in the tag readers 104. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

### Example Implementation

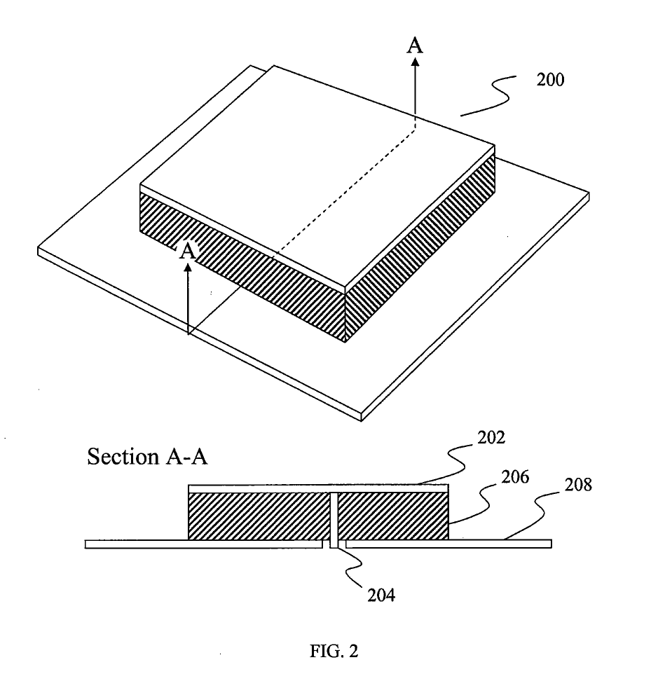

FIG. 2 shows an example of a low cost, light-weight single microstrip element antenna 200. Such a microstrip element antenna 200 can be used, for example, on a reader 104 or on one or more tags 102 in an environment described above with reference to FIG. 1. Microstrip element antenna 200 is also known as a patch antenna, as is well known to those skilled in the art. As shown in FIG. 2, microstrip element antenna 200 comprises of various layers including a radiator layer 202, a skeleton rib structured dielectric spacer 206, a ground plane layer 208 and transfer mechanism 204 for applying electrical energy to the radiator layer 202. Radiator layer 202 can be made of flexible materials like plastic or any other flexible materials, well known to those skilled in the art. In an alternative embodiment, radiator layer 202 can be made of a stiff material like a metal. Radiator layer 202 can further include additional electronics components, resonating elements, circuit traces, and the like residing on. Such electronics components, circuit traces or resonating elements can be placed on the radiator layer 202 by various fabrication techniques, such as thin-film technology. Description of such fabrication technologies is beyond the scope of this specification, and is well known to those skilled in the art. Skeleton rib structured dielectric spacer 206 can be any dielectric material, for example and not by way of limitation, organic compounds, alloys or plastic, well known to those skilled in the art. Ground plane layer 208 serves the purpose of an electrical ground for circuit traces and resonating elements residing on radiator layer 202. Ground plane layer 208 can be made of, for example and not by way of limitation, any standard metal like copper or a suitable alloy, well known to those skilled in the art. Further, ground plane layer 208 and radiator layer 202 can be attached to dielectric spacer 206 by at least one self adhesive layer (not shown in FIG. 2).

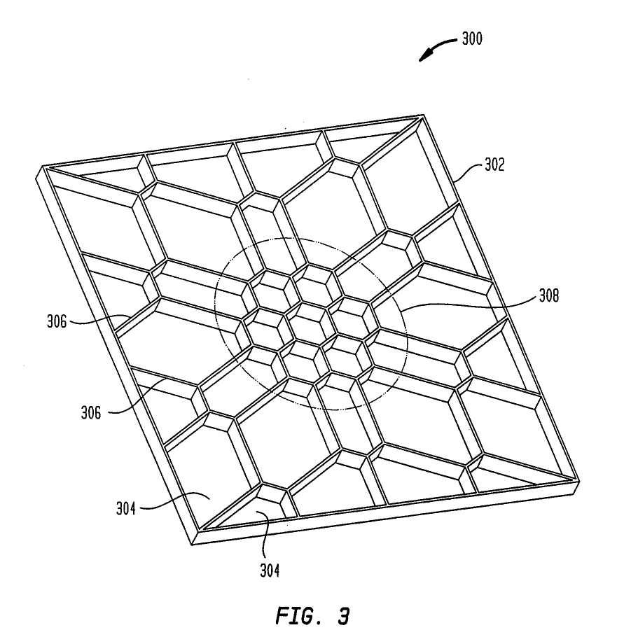

FIG. 3 shows a cross-section 300 of skeleton rib structured dielectric spacer 206. As shown in FIG. 3, skeleton rib structured dielectric spacer 206 has a periphery 302. Periphery 302, as shown in FIG. 3 is continuous. However, in other embodiments of the present invention, periphery 302 can be discontinuous. The density of skeleton rib structured dielectric spacer 206 may increase or decrease from periphery 302 towards a center of skeleton rib structured dielectric spacer 206.

As shown in FIG. 3, cross-section 300 consists of a plurality of empty spaces 304 and a plurality of rib-arms 306. Rib-arms 306 form a skeleton rib structure to add mechanical strength to microstrip element antenna 200. As can be seen in FIG. 3, there is a variation in the density of rib-arms 306 from periphery 302 towards a region 308 encompassing a center of cross-section 300. Towards the center of cross-section 300, the density of rib-arms 306 is higher as compared to the density of rib-arms 306 towards periphery 302. Such a variation in density of rib-arms 306 can be of different designs based upon geometrical patterns that rib-arms 306 are laid according to. Due to a network of rib-arms 306, a cross-section 300 of a network of rib arms 306 has a dielectric constant that is between air and the dielectric constant of dielectric spacer material forming the rib-arms 306 of the network. As a result, a designer has flexibility of modifying dielectric properties of skeleton rib structured dielectric spacer 206 merely by changing or selecting the geometry in which rib-arms 306 are arranged, within a set of parameters required for efficient operation of microstrip element antenna 200.

Due to a skeleton like framework of the network of rib-arms 306, overall dielectric material required for microstrip element antenna 200 is also reduced. Further, since skeleton rib structured dielectric spacer 206 has a higher surface area to volume ratio (relative to a solid body dielectric spacer), curing or freezing time for the dielectric material is also reduced thereby reducing manufacturing cycle time.

According to one embodiment of the present invention, dielectric properties of cross-section 300 have a greater effect near periphery 302, as compared to that near a center of cross-section 300, around region 308. However, this effect can be reversed depending on specific applications. Further, due to a non-uniform variation in dielectric properties across cross-section 300, effective resonant radiator size of microstrip element antenna 200 can be larger or smaller for a same resonant frequency, relative to a solid body dielectric spacer microstrip element antenna. As is well known to those skilled in the art, a larger resonant radiator size will have higher antenna gain and antenna directivity; conversely a smaller resonant radiator size will have lower antenna gain and lower antenna directivity where beam broadening is desired; either effect can be advantageous in many applications.

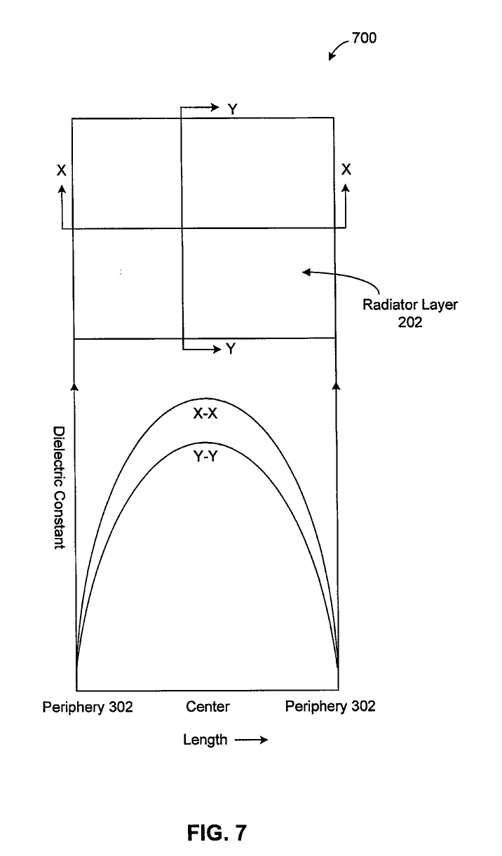

According to yet another embodiment of the present invention, variation in dielectric properties of microstrip element antenna 200 can be used to compensate for leakage, field pattern distortion and losses occurring due to an oblong ground plane. One can, for example, control the variation of dielectric properties along X and Y axes and thereby design microstrip element antenna 200 according to an adjustable axial ratio and impedance distribution. Similar techniques for variation of dielectric properties, well known to those skilled in the art, can be applied for providing immunity from electromagnetic interference due to external hardware components or a predominant orientation of RFID tags 102a-102g in environment 100. One such variation in distribution of impedance across an axis of polarization is shown in FIG. 7 with reference to plot 700. As shown in plot 700, the dielectric constant of microstrip element antenna 200 varies from periphery 302 to a center of microstrip element antenna 200. Such a distribution allows for compensation for axial ratio and enables an increase in radiator size (and consequent gain) for same resonant frequency. Other distributions will be apparent to those skilled in the art after reading this disclosure and can be realized depending on specific applications.

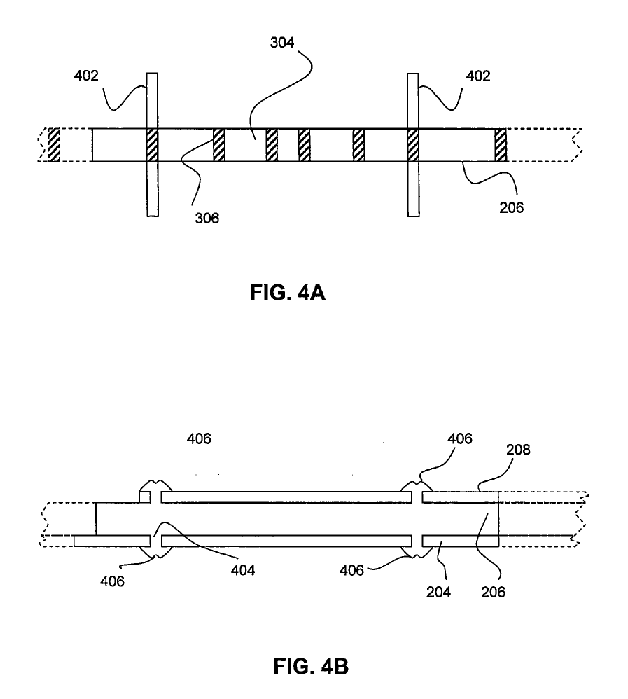

FIG. 4A shows a portion of skeleton rib structured dielectric spacer 206 with studs 402 attached for ultrasonic staking. Studs 402 can be of any material, like plastic, for example and not by way of limitation. Studs 402 are made to pass through holes 404 in ground plane layer 208 and radiator layer 202 , as shown in FIG. 4B. By keeping the length of studs 402 constant, the distance between ground plane layer 208 and radiator layer 202 is kept constant.

After studs 402 are made to pass through holes 404, horns 406 are attached to studs 402. An ultrasonic pulse fuses horns 406 to studs 402 resulting in a permanent fixture. Ultrasonic staking can further be of different types like low profile staking; dome staking; knurled staking; flush staking; hollow staking; or any other type well known to one skilled in the art. Once horns 406 are attached to studs 402, ground plane layer 208 and radiator layer 202 are at a fixed distance from each other.

Although, the staking process described herein is ultrasonic staking, other staking techniques, like heat staking, for example, can also be used, as is well known to those skilled in the art.

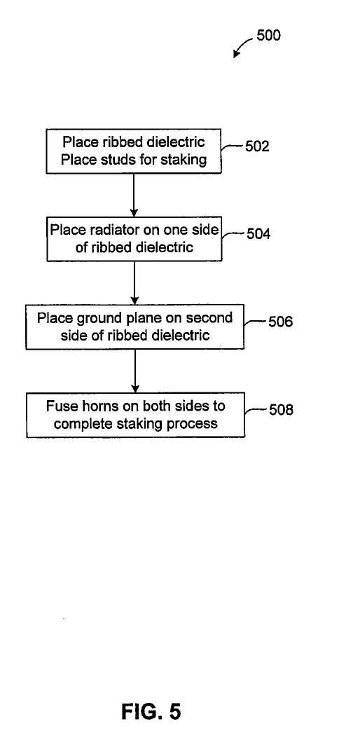

FIG. 5 shows a flowchart illustrating process 500 for assembling microstrip element antenna 200 by means of ultrasonic staking process described in FIGS. 4A-4B. In step 502, skeleton rib structured dielectric spacer 206 is attached to studs 402 such that studs 402 pass through a plane perpendicular to cross-section 300 of skeleton rib structured dielectric spacer 206.

In step 504, on a first side of skeleton rib structured dielectric spacer 206, a radiator layer 202 with holes 404 is placed such that studs 402 pass through the holes 404 in radiator 202.

Similarly, in step 506, on a second side of skeleton rib structured dielectric spacer 206, a ground plane layer 208 with holes 404 is placed such that studs 402 pass through the holes 404 in ground plane layer 208.

Finally, in step 508, horns 406 are fused ultrasonically or otherwise to studs 402 such that ground plane layer 208 and radiator layer 202 are at a fixed distance from each other.

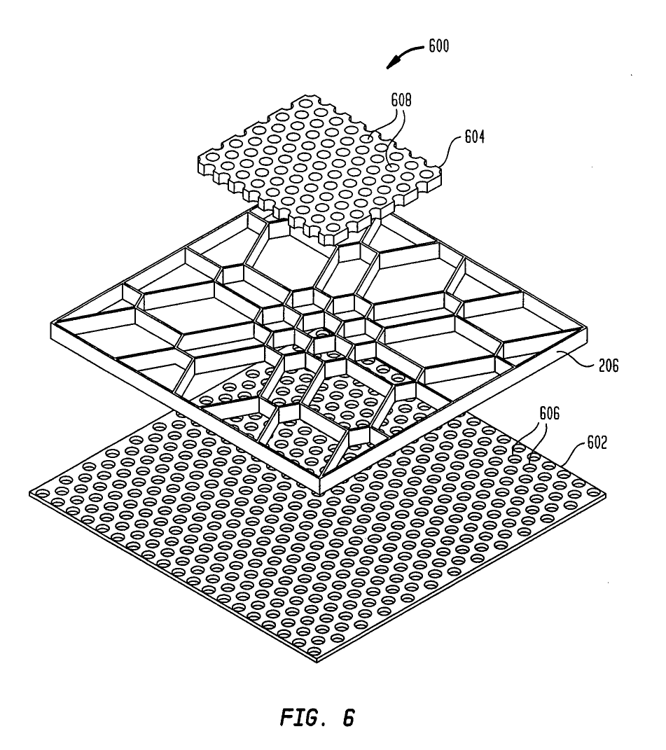

FIG. 6 shows a structure 600 with a perforated ground plane 602 with a plurality of holes 606. Similarly, a perforated radiator layer 604 has a plurality of holes 608. Skeleton rib structured dielectric spacer 206 is placed in between perforated ground plane 602 and perforated radiator layer 604. Structure 600 has the advantage of having a fast drying time in an event of a water or moisture ingress. Further, with structure 600 it is easier to get rid of any other form of contaminants like dust, for example, that may creep into structure 600 during manufacture of microstrip element antenna 200. Additionally, having perforated radiator layer 604 and perforated ground plane 602, leads to a further reduction in overall weight of microstrip element antenna 200, and also a reduction in overall cost of materials involved. Perforated radiator layer 604, dielectric spacer 206 and perforated ground plane 602 are shown having different dimensions for illustrative purposes only. It will be apparent to one skilled in the art that the dimensions of perforated radiator layer 604, dielectric spacer 206 and perforated ground plane 602 are a design choice depending upon specific applications. For example, perforated radiator layer 604, dielectric spacer 206 and perforated ground plane 602 can be of equal dimensions.

Alternative embodiments of the microstrip element antenna 200 can be contemplated by those skilled in the art after reading this disclosure. Further, microstrip element antenna 200 may be used in conjunction with any type of reader antenna known to persons skilled in the relevant art(s), including a vertical, dipole, loop, Yagi-Uda, or slot antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

The present invention is applicable to dielectric spacer design process of any type of microstrip element antenna 200, for example a patch antenna. Microstrip element antenna 200 can further include a substrate and an integrated circuit (IC). Further, microstrip element antenna 200 may include any number of one, two, or more separate antennas and thus, can be a part of an antenna array. Further still, in an array configuration, microstrip element antenna 200 can be implemented as any suitable antenna type, including dipole, loop, slot, or patch antenna type.

In an embodiment, the present reader described in FIG. 1 is configured to use a “near-field” antenna configuration, such as described above, including in a patch, linear, or loop antenna configuration. Another near-field antenna example is a lossy transmission line type antenna.

Example embodiments of the present invention can be used as attachable accessories for example mobile handheld devices. The mobile devices can be any of a universal wireless handheld device, an NG phaser device, an MC50 enterprise digital assistant, an MC1000 handheld computer, an MC3000 mobile computer, and an MC70 enterprise digital assistant, each distributed by Symbol Technologies, Inc., of Holtsville, N.Y.

### Example Advantages of Embodiments

Numerous advantages are provided by embodiments of the present invention, some of which were described above. Example advantages are described. For example, embodiments have a small size that is easy to integrate into mobile terminals. The microstrip element antenna 200 embodiments are very light weight. Embodiments can be integrated into a SANDISK™ (SD) format card to upgrade numerous existing products and devices that are compatible with SD cards.

The design flexibility offered by means of controlling dielectric properties of the sandwiched dielectric spacer is also advantageous in many ways. Fundamental to the implementation of a microstrip element antenna is the interaction with the ground plane. Thus, selection of ground plane is important to the performance of the antenna system. For example, changing ground plane size can effect the beam pattern and gain of an antenna. Additionally, changing ground plane size can de-tune the antenna effectively shifting its center frequency. It is also well known that any distortion or oblongation in the ground plane shape can degrade the axial ratio of the antenna system. This is especially true when mounting the antenna element to a printed circuit board (PCB) when asymmetrical placements can degrade the antenna performance. The ability to modify the dielectric properties of the microstrip element antenna by way of a skeleton rib structured dielectric spacer, according to various embodiments of the current invention, aids in compensating for problems mentioned immediately above. Selection of particular parameters for the ground plane is a design choice based on the specific application.

Embodiments may be packaged on a rigid or flexible substrate. For example, a flex substrate may include an antenna strip (trace in flex). The flex can be adhered to the inside contours of existing, or new housings. Embodiments can have multiple antenna strips supporting multiple frequencies. Microstrip element antenna 200 can be in the form of strips that could be optimized for contact reading, as well as close range reading, e.g., 0 to 3″ or 0 to 6″ ranges.

Conventional systems tend to perform “far field” reads of RFID tags. According to the embodiments, as described above, a “near field” read can be performed (or very short far field read) by a reader on which microstrip element antenna 200 may reside. Additionally, as mentioned earlier, microstrip element antenna 200 may also reside on one or more RFID tags. A space or region immediately surrounding an antenna in which reactive components predominate, is known as the reactive near field region. The size of this region varies for different antennas. For most antennas, however, the outer limit of a near field read is on the order of a few wavelengths or less. Beyond the reactive near field region, the “radiating field” predominates. The radiating region is divided into two sub-regions, the “radiating near field” region and the “far field” region. In the radiating near field region, the relative angular distribution of the field (the usual radiation pattern) is dependent on the distance from the antenna. In a far field region, the relative angular distribution of the field becomes independent of the distance. According to the present invention, it is possible to increase the distance into the far field region by increasing the antenna gain without detriment to the ability to read tags in the near field.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A microstrip antenna comprising:
a ground plane;
a radiator; and
a dielectric spacer defined by a body that has a non-uniform dielectric constant across the body.

2. The microstrip antenna of claim 1, wherein the dielectric spacer has a skeleton rib structure.

3. The microstrip antenna of claim 1, wherein density of the skeleton rib structure increases from a periphery of the skeleton rib structure towards a center of the skeleton rib structure.

4. The microstrip antenna of claim 1, wherein density of the skeleton rib structure decreases from a periphery of the skeleton rib structure towards a center of the skeleton rib structure.

5. The microstrip antenna of claim 1, wherein the ground plane is positioned at a set distance from the radiator by ultrasonic staking.

6. The microstrip antenna of claim 1, wherein the ground plane and the radiator are both made of respective perforated metal sheets.

7. The microstrip element antenna of claim 1, wherein the dielectric spacer has a geometry substantially similar to FIG. 3.

8. The microstrip antenna of claim 1, wherein the ground plane, the radiator and the dielectric spacer are each made of flexible material.

9. A method for assembling a light weight microstrip antenna, comprising:
forming a skeleton rib structured dielectric spacer;
attaching a ground plane to a first surface of the skeleton rib structured dielectric spacer; and
attaching a radiator to a second surface of the dielectric spacer at a fixed distance from the ground plane.

10. The method of claim 9, further comprising the step of perforating at least one of the ground plane and the radiator plane.

11. The method of claim 9, wherein the forming step includes selecting a geometrical shape of the skeleton rib structured dielectric spacer so as to make an effective dielectric constant equal to a preset dielectric constant value.

12. The modulating step of claim 9, wherein the step of forming includes:
varying rates of modulation of the dielectric constant along first and second dimensions of the skeleton rib structured dielectric spacer.

13. The method of claim 9, further comprising keeping the distance between the ground plane and the radiator constant by using at least one of ultrasonic staking or heat staking.

14. The method of claim 13, wherein the ultrasonic staking includes one or more of:
(a) Low profile staking;
(b) Dome staking;
(c) Knurled staking;
(d) Flush staking; and
(e) Hollow staking.

15. The method of claim 8, further comprising placing a self adhesive layer between the skeleton rib structured dielectric spacer, the ground plane and the radiator.
